(19) United States
(12) Patent Application Publication
(10) Pub. No.: US 2010/0177127 A1
(43) Pub. Date: Jul. 15, 2010

(54) LED DRIVING CIRCUIT, SEMICONDUCTOR ELEMENT AND IMAGE DISPLAY DEVICE

(75) Inventors: Noboru AKIYAMA, Hitachinaka (JP); Takayuki HASHIMOTO, Naka-gun (JP); Takashi HIRAO, Hitachi (JP); Nobuyoshi MATSUURA, Takasaki (JP)

Correspondence Address: BRUNDIDGE & STANGER, P.C., 2318 MILL ROAD, SUITE 1020, ALEXANDRIA, VA, 22314, US

(73) Assignee: RENESAS TECHNOLOGY CORP.,, Tokyo (JP)

(21) Appl. No.: 12/683,697

(22) Filed: Jan. 7, 2010

(30) Foreign Application Priority Data
Jan. 9, 2009 (JP) 2009-003289

(51) Int. Cl. G06F 3/038; G09G 5/10

(52) U.S. Cl. 345/690; 345/211; 345/102

(57) ABSTRACT

An LED driving circuit driving an LED array includes: n constant-current driving elements having a vertical structure, each of which is connected to each of LED strings in series and drives the LED string with a constant current; n constant-current control circuits controlling on voltages of the constant-current driving elements so that currents flowing to the LED strings become constant currents; a lowest-voltage detecting circuit to which terminal voltages of the constant-current driving elements on an LED string side are inputted, the lowest-voltage detecting circuit selecting a lowest voltage from among the terminal voltages and outputting a command signal based on difference between the lowest voltage and a predetermined set voltage; and a power-supply control circuit controlling a voltage applied to the LED array to a voltage lower than an initial set voltage based on the command signal.

### CROSS-REFERENCE TO RELATED APPLICATION

The present application claims priority from Japanese Patent Application No. JP 2009-003289 filed on Jan. 9, 2009, the content of which is hereby incorporated by reference into this application.

### TECHNICAL FIELD OF THE INVENTION

The present invention relates to a technique for driving light emitting diodes (LEDs), and in particular to a technique effectively applied to an LED driving circuit which drives an LED array, a semiconductor element used in the LED driving circuit, and an image display device having an LED array and the LED driving circuit.

### BACKGROUND OF THE INVENTION

LEDs that emit white light have been used for the backlight of a liquid crystal panel for use in a mobile phone and the like. In order to uniform the light-emission luminance of the LEDs without unevenness, the LEDs have to be driven with a constant current so that a predetermined constant current flows to the LEDs.

As a technique related to that, U.S. Pat. No. 6,621,235 (Patent Document 1) discloses the technique for causing an LED array, in which a large number of LED elements are arranged in series and in parallel, to uniformly emit light. Also, Japanese Patent Application Laid-Open Publication No. 2006-319057 (Patent Document 2) and Japanese Patent Application Publication No. 2005-537669 (Patent Document 3) disclose the techniques for controlling the voltage applied to an LED array in accordance with the variation in forward voltages V_{F} of LEDs so as to prevent the voltages applied to constant-current driving elements from being increased unnecessarily. Furthermore, LM3432 Data Sheet “LM3432/LM3432B 6-Channel Current Regulator for LED Backlight Application”, National Semiconductor Corporation, May 22, 2008 (Non-Patent Document 1) discloses the technique for suppressing the inrush current to LEDs generated at the digital dimming of an LED array.

### SUMMARY OF THE INVENTION

When LEDs are used for the backlight of a large liquid crystal panel for use in a TV set, display or the like, the current which flows to an LED array has to be further increased. However, in the technique disclosed in Patent Document 1, the problem of increase in a chip area and heat generation when the LED current is increased occurs because a plurality of constant-current driving elements (transistors or metal oxide semiconductor field effect Transistors (MOSFETs)) are integrated (made into an Integrated Circuit (IC)) on one chip. For its prevention, it is conceivable to drive the current corresponding to one row (one string) of the LED array by the plurality of constant-current driving elements disposed in parallel. However, in this case, there is a problem that the number of required driving elements is increased, and as a result, the number of IC chips to be used is increased.

Moreover, in the techniques disclosed in Patent Document and Patent Document 3, no consideration is given to the control of a power supply circuit in the case where the LED current is rapidly changed from a constant current to a zero current or from a zero current to a constant current like in the case of digital dimming. Also, in the technique disclosed in Non-Patent Document 1, no consideration is given to the increase in dimming signal wiring in the case where the number of the IC chips for constant-current drive is increased as described above with the increase in the LED current.

Therefore, an object of the present invention is to provide an LED driving circuit capable of carrying out constant-current drive while suppressing the increase in the mounting area even when a high current flows to an LED array. The above and other objects and novel characteristics of the present invention will be apparent from the description of this specification and the accompanying drawings.

The typical ones of the inventions disclosed in this application will be briefly described as follows.

An LED driving circuit according to a typical embodiment of the present invention is an LED driving circuit driving an LED array in which n LED strings in each of which m LEDs are connected in series are arranged in parallel, the LED driving circuit comprising: n first semiconductor elements having a vertical structure, each of which is connected to each of the LED strings in series and drives the LED string with a constant current; n constant-current control circuits controlling on voltages of the first semiconductor elements so that currents flowing to the LED strings become constant currents; a lowest-voltage detecting circuit to which terminal voltages of the first semiconductor elements on an LED string side are inputted, the lowest-voltage detecting circuit selecting a lowest voltage from among the terminal voltages and outputting a command signal based on difference between the lowest voltage and a predetermined set voltage; and a power-supply control circuit controlling a voltage applied to the LED array to a voltage lower than an initial set voltage based on the command signal from the lowest-voltage detecting circuit.

The effects obtained by typical embodiments of the inventions disclosed in this application will be briefly described below.

According to typical embodiments of the present invention, the number of elements for driving LEDs with a constant current can be reduced, and the increase in the mounting area can be suppressed even when a high current flows to the LEDs.

### BRIEF DESCRIPTIONS OF THE DRAWINGS

FIG. 1 is a functional block diagram showing a configuration example of an LED driving circuit according to a first embodiment of the present invention;

FIG. 2 is a functional block diagram showing a configuration example of an LED array and a current regulator according to the first embodiment of the present invention;

FIG. 3A is a plan view showing an example of the structure of a constant-current driving element (n-channel vertical MOSFET) according to the first embodiment of the present invention;

FIG. 3B is a cross-sectional view showing an example of the structure of a unit cell constituting the n-channel vertical MOSFET;

FIG. 4 is a functional block diagram showing an example of constant-current driving elements, constant-current control circuits, and a circuit configuration in the case where they are mounted in packages according to the first embodiment of the present invention;

FIG. 5 is a functional block diagram showing a configuration example of the LED driving circuit and a power-supply control circuit according to the first embodiment of the present invention;

FIG. 6 is a functional block diagram showing a configuration example of a lowest-voltage detecting circuit according to the first embodiment of the present invention;

FIG. 7 is a drawing showing an example of the operation waveforms of an LED current and a dimming signal in digital dimming according to the first embodiment of the present invention;

FIG. 8 is a functional block diagram showing a configuration example of the LED array and the current regulator in the case where dimming signal wiring according to a conventional technique is used;

FIG. 9 is a graph showing the relation between the number of the LEDs connected in series and the number of the LED strings connected in parallel and the rated voltages of the constant-current driving elements according to the first embodiment of the present invention;

FIG. 10 is a graph showing the relation between the output currents and the total number of LEDs in the LED driving circuits according to the first embodiment of the present invention and the conventional technique;

FIG. 11 is a functional block diagram showing a configuration example of the LED array and the current regulator in the LED driving circuit according to a second embodiment of the present invention;

FIG. 12 is a functional block diagram showing a circuit configuration and a configuration example of a package in the case where the plurality of constant-current driving elements and the constant-current control circuit are mounted in one package according to the second embodiment of the present invention;

FIG. 13 is a drawing showing an example of a mounting state of the package according to the second embodiment of the present invention;

FIG. 14 is a graph showing the relation between the LED current per one channel and the mounting area of the current regulator in the LED driving circuits according to the first and second embodiments of the present invention and a conventional technique;

FIG. 15 is a functional block diagram showing a configuration example of the LED driving circuit according to a third embodiment of the present invention;

FIG. 16 is a functional block diagram showing a circuit configuration and a configuration example of the package in the case where a plurality of constant-current driving elements and a constant-current control circuit according to the third embodiment of the present invention are mounted in one package;

FIG. 17 is a drawing showing an example of the mounting state of the package according to the third embodiment of the present invention;

FIG. 18 is a functional block diagram showing an example of the circuit configuration of the lowest-voltage detecting circuit according to the third embodiment of the present invention;

FIG. 19 is a functional block diagram showing a circuit configuration and a configuration example of the package in the case where a plurality of constant-current driving elements and a constant-current control circuit according to a fourth embodiment of the present invention are mounted in one package;

FIG. 20 is a drawing showing an example of the mounting state of a package according to the fourth embodiment of the present invention;

FIG. 21 is a functional block diagram showing a configuration example of an LED array and a current regulator in the conventional technique; and

FIG. 22 is a graph showing the relation between the LED current per one channel and the mounting area of a current regulator in the conventional technique.

### DESCRIPTIONS OF THE PREFERRED EMBODIMENTS

Hereinafter, embodiments of the present invention will be described in detail with reference to the accompanying drawings. Note that components having the same function are denoted by the same reference numbers throughout the drawings for describing the embodiments, and the repetitive description thereof will be omitted.

An LED driving circuit according to an embodiment of the present invention is a driving circuit of an LED array in which n LED strings in each of which m LEDs are connected in series are arranged in parallel, and the driving circuit has a plurality of semiconductor elements which carry out control so that a uniform constant current flows to the LED array.

Here, vertical elements having a low on resistance compared with lateral elements are used as the constant-current driving elements which are the semiconductor elements connected to the LED strings in series to drive the LED strings with a constant current. By this means, the number m of the LEDs connected in series is increased and the number n of the LED strings arranged in parallel is reduced to reduce the number of the elements for driving the LEDs with a constant current (constant-current driving elements and constant-current control circuits for controlling the constant-current driving elements to carry out constant-current drive).

Also, a lowest-voltage detecting circuit which selects the lowest voltage of the terminal voltages of the n constant-current driving elements on the LED string side, compares the lowest voltage with a predetermined set voltage, and then outputs a command signal based on the difference therebetween is provided. Based on the command signal from the lowest-voltage detecting circuit, the power-supply control circuit controls the voltage applied to the LED array to an appropriate voltage lower than the initial set voltage. Further, the lowest-voltage detecting circuit outputs the command signal when the constant-current driving elements are in the constant-current drive state (digital dimming signal is low level) and stops the output of the command signal when the constant-current driving elements are in an off state or in a state close to an off state (digital dimming signal is high level) based on the digital dimming signal at the time of the digital dimming.

Furthermore, the LED driving circuit according to an embodiment of the present invention has a delay circuit which delays the digital dimming signal inputted to the constant-current control circuit. The constant-current control circuit outputs the digital dimming signal delayed by the delay circuit and inputs the signal to a constant-current control circuit of the next stage, that is, the constant-current control circuit that controls the current of the LED string of the next channel.

### First Embodiment

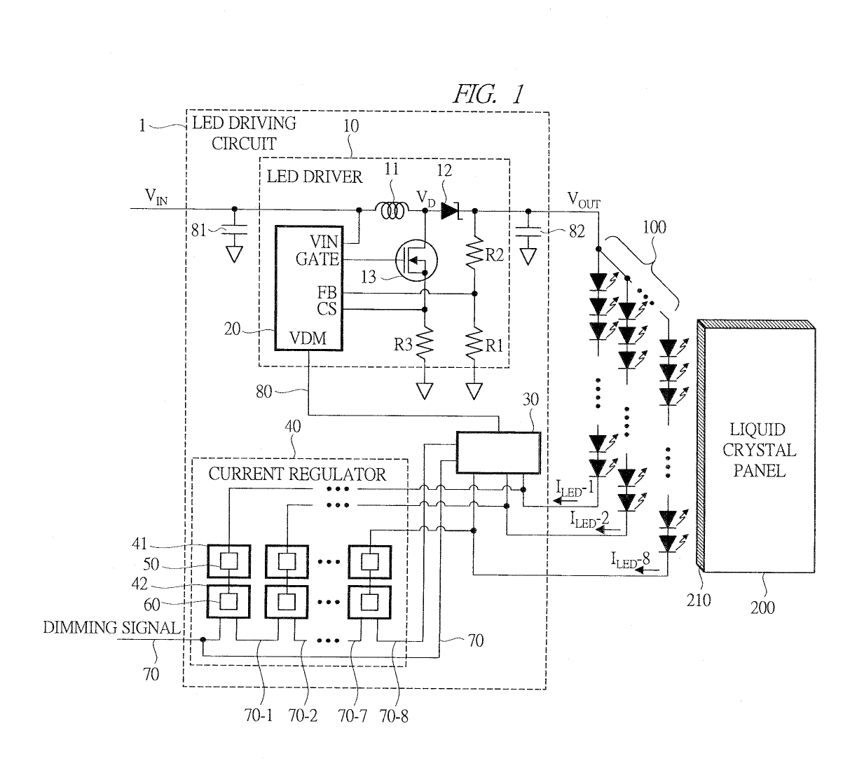

Hereinafter, an LED driving circuit according to a first embodiment of the present invention will be described with reference to FIG. 1 to FIG. 10. FIG. 1 is a functional block diagram showing a configuration example of the LED driving circuit according to the first embodiment of the present invention. In FIG. 1, an LED driving circuit 1 is connected to an LED array 100, and has an LED driver 10, which is a power supply circuit to supply a voltage to be applied to LEDs, a current regulator 40 for driving the LED array 100 with a constant current, and a lowest-voltage detecting circuit 30.

The LED array 100 is disposed on a bottom surface 210 side of a liquid crystal panel 200 so as to be arranged in a row as the LED backlight of the liquid crystal panel 200 of an edge light system. The light which comes in from the bottom surface 210 travels in a light guiding plate (not shown) in the liquid crystal panel 200, is diffused by a light diffusion film (not shown) and then illuminates a back surface of the liquid crystal panel 200 with white light. Images are displayed on a front surface of the liquid crystal panel 200 when the white light is polarized by liquid crystal elements (not shown).

Hereinafter, the internal configurations and operations of the current regulator 40, the lowest-voltage detecting circuit 30 and the LED driver 10 in the LED driving circuit of the present embodiment will be described.

The current regulator 40 is connected in series with LED strings, in each of which a plurality of LEDs are connected in series. The current regulator 40 is made up of a plurality of constant-current driving elements 50 which drive the LED array 100 with a constant current and a plurality of constant-current control circuits 60 which control the on voltages of the constant-current driving elements 50 so that the LED currents flowing to the LED strings become constant currents, and each of the constant-current driving elements 50 and each of the constant-current control circuits 60 are mounted in packages 41 and 42, respectively.

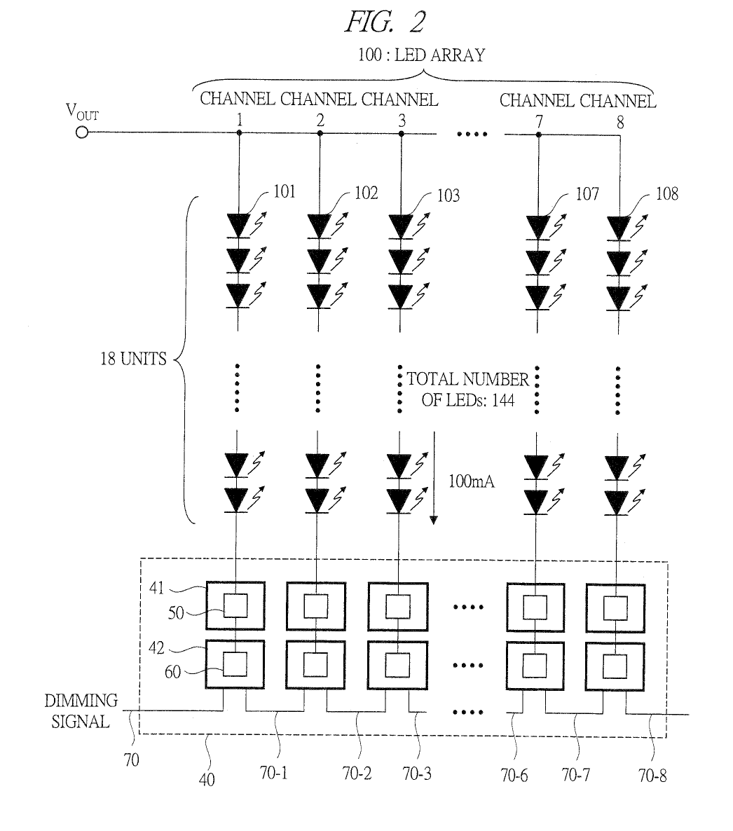

FIG. 2 is a functional block diagram showing a configuration example of the LED array 100 and the current regulator 40 of FIG. 1. In the example of FIG. 2, the case where the total number of the LEDs is 144 is shown, and eight LED strings (LED strings 101 to 108) in each of which 18 LEDs are connected in series are connected in parallel, thereby constituting channels (channels 1 to 8) of the LED array 100.

A dimming signal is inputted to the constant-current control circuit 60, which controls the current of the LED string 101, via a dimming signal wiring 70, and the dimming signal delayed by a delay circuit therein, which will be described later, is outputted therefrom. The outputted dimming signal is inputted to the constant-current control circuit 60, which controls the current of the next LED string 102, via a dimming signal wiring 70-1, and similarly, the dimming signal delayed by a delay circuit therein is outputted therefrom. In this manner, the dimming signal is delayed by the delay circuits in the constant-current control circuits 60 and sequentially transmitted to the constant-current control circuit 60 of the next stage.

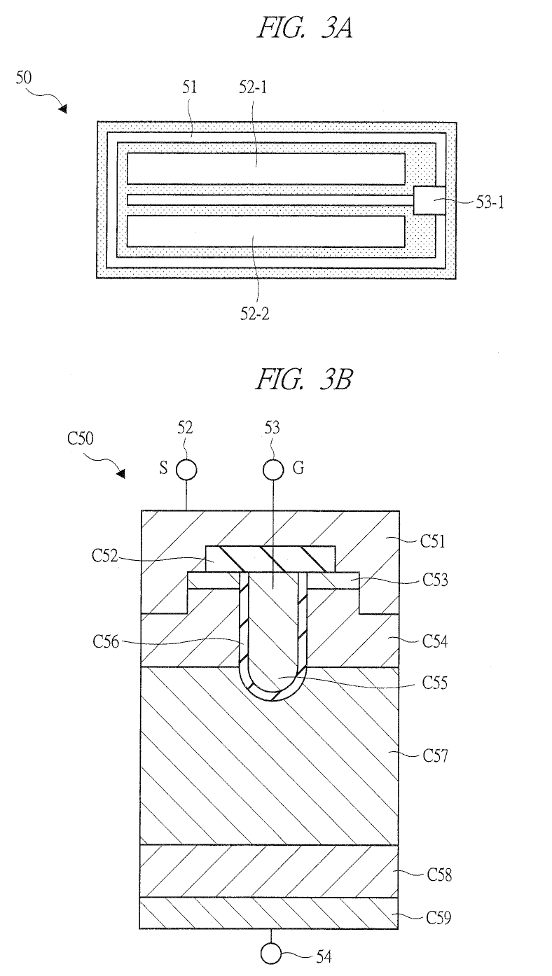

Herein, a semiconductor element having a vertical structure is used as the constant-current driving element 50. FIGS. 3A and 3B are drawings showing an example of a structure of an n-channel vertical MOSFET which is an example of the constant-current driving element 50. FIG. 3A is a plan view showing the example of the structure of the constant-current driving element 50 (n-channel vertical MOSFET), and FIG. 3B is a cross-sectional view showing an example of the structure of a unit cell constituting the n-channel vertical MOSFET shown in FIG. 3A.

In FIG. 3B, the unit cell C50 is made up of a metal thin film (for example, aluminium thin film) C51 to be a source electrode 52, an insulating film C52, an n⁺-type semiconductor region C53, a p-type semiconductor region C54, an n⁺-type polycrystalline semiconductor region C55 to be a gate electrode 53, a gate oxide film C56, an n⁻-type semiconductor region C57, an n⁺-type semiconductor region C58, and a metal thin film C59 to be a drain electrode 54. The width of the unit cell C50 is about 1 to 2 μm, and when several thousands of the unit cells C50 are arranged, the transistor part of the constant-current driving element 50 (n-channel vertical MOSFET chip) is formed. For example, an assembly of the metal thin films C51 serves as a source electrode pad 52-1 of FIG. 3A.

In FIG. 3A, the constant-current driving element 50 (n-channel vertical MOSFET) further includes a gate electrode pad 53-1 and gate finger wirings 51 made of a metal thin film (for example, aluminium thin film). The gate finger wiring 51 is provided to reduce the wiring resistance of the part from the n⁺-type polycrystalline semiconductor region C55 to the gate electrode pad 53-1, which forms the gate electrode 53.

In FIG. 3B, in order to facilitate the understanding of the electrode structure of the unit cell C50, terminal lines are drawn from the regions to be the electrodes and schematically shown like S (source), G (gate) and D (drain). In the unit cell C50, a current flows in the vertical direction from the drain electrode 54 side (metal thin film C59 side) to the source electrode 52 side (metal thin film C51 side). The vertical MOSFET is an element in which a channel is formed in the vertical direction (thickness direction) of a semiconductor chip and has characteristics that the channel width per unit area can be increased compared with a lateral MOSFET and the on resistance thereof is low compared with a lateral element.

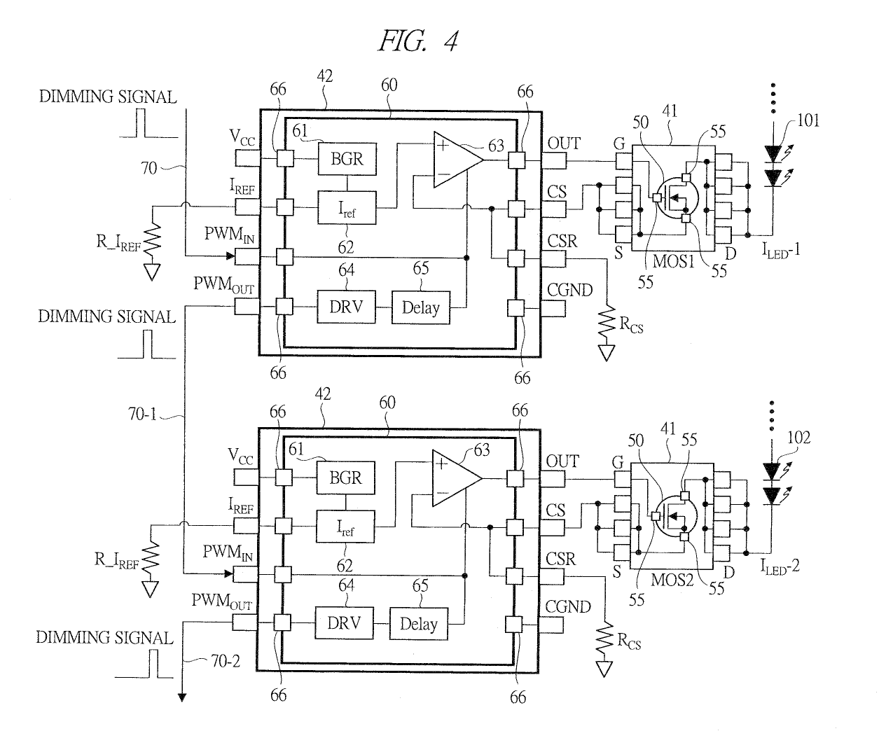

FIG. 4 is a functional block diagram showing an example of the constant-current driving elements 50, the constant-current control circuits 60, and a circuit configuration in the case where they are mounted in packages. The constant-current control circuit 60 is a semiconductor integrated circuit in which a bandgap reference power supply (BGR) 61, a voltage level shift element (I_{ref}) 62 for LED current setting, an operational amplifier 63, a delay circuit (Delay) 65 for delaying the inputted dimming signal, and a drive circuit (DRV) 64 which outputs the delayed dimming signal are integrated on one chip.

The package 42 in which the constant-current control circuit 60 is mounted is provided with a power supply terminal V_{CC}, an LED current setting terminal I_{REF}, an input terminal PWM_{IN} and an output terminal PWM_{OUT} of the digital dimming signal (hereinafter, simply described as “dimming signal” in some cases), an output terminal OUT of the operational amplifier 63, a current sense terminal CS, a sense resistor terminal CSR, and a logic ground terminal CGND. Electrode pads 55 and 66 of the constant-current driving element 50 and the constant-current control circuit 60 are respectively connected to the terminals of the packages 41 and 42 by gold wires or the like. Regarding the terminals of the package 41 in which the constant-current driving element 50 is mounted, a drain terminal D is connected to the cathode of the LED string 101, a gate terminal G is connected to the output terminal OUT of the operational amplifier 63, and a source terminal S is connected to the CS terminal.

The LED current which has flown through the LED string 101 is inputted to the drain of the constant-current driving element 50, outputted from the source thereof, flows through a sense resistor R_{CS} via the CS terminal and the CSR terminal of the constant-current control circuit 60 (the CS terminal and the CSR terminal are short-circuited in the interior thereof), and reaches the ground. The voltage generated at the CSR terminal by the LED current which has flown through the sense resistor R_{CS} is inputted to an inverting input terminal of the operational amplifier 63. Feedback is applied to the output of the operational amplifier 63 so that this voltage is matched with the voltage set by the resistance R-I_{REF} of the terminal I_{REF}, and the on resistance of the constant-current driving element 50 is adjusted. Therefore, a predetermined constant current flows to the LED string 101. The series of operations are the same also in the other LED strings 102 to 108.

Note that the operational amplifier 63 incorporates a switch circuit (not shown) in addition to a conventional operational amplifier circuit and has a function of turning off the vertical MOSFET by forcibly setting the gate voltage of the constant-current driving element 50 to a low level when the voltage of the dimming signal inputted from the PWM_{IN} terminal is high level. This is the same also in subsequent embodiments.

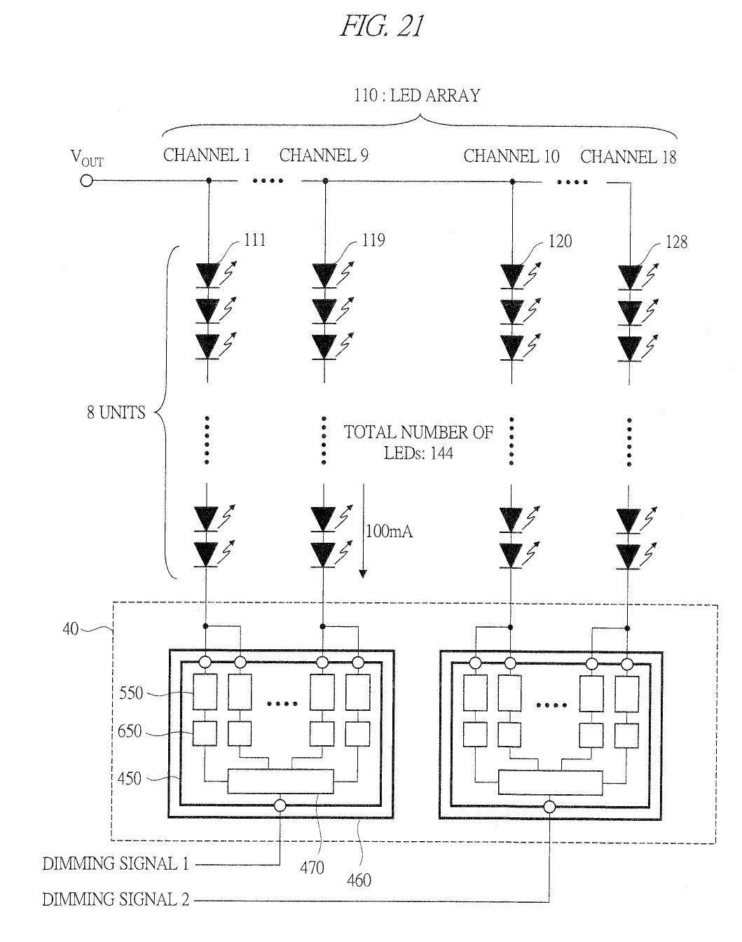

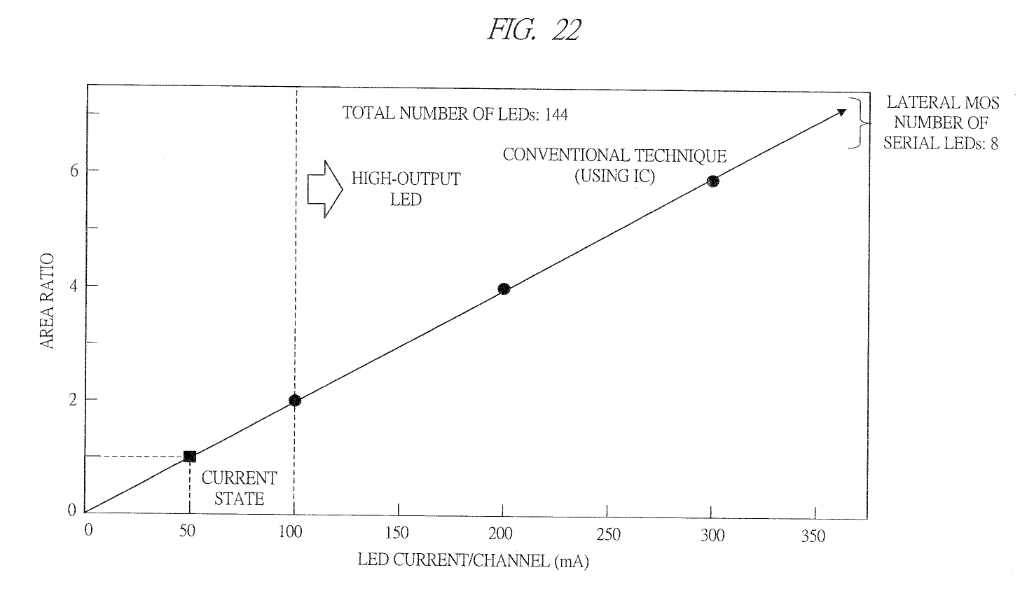

A conventional technique will now be simply described with reference to FIG. 21 and FIG. 22. FIG. 21 is a functional block diagram showing a configuration example of an LED array and a current regulator in the conventional technique. The example of FIG. 21 shows the case where the total number of LEDs is 144 similarly to the case of FIG. 2, and 18 LED strings (LED strings 111 to 128) in each of which eight LEDs are connected in series are connected in parallel, thereby constituting channels (channels 1 to 18) of the LED array 110.

A current regulator 40 is connected to the LED array 110 similarly to the case of FIG. 2. The current regulator 40 has packages 460 in which current regulator ICs 450 are mounted. The current regulator IC 450 has constant-current driving elements 550 which drive the LED array 110 with a constant current, constant-current control circuits 650 which control the constant-current driving elements 550 so that the LED current becomes a constant current, and a timing generating circuit 470 which outputs an inputted digital dimming signal (dimming signal 1 or 2) to each of the constant-current control circuits 650 in the current regulator IC 450 at the timings varied little by little.

The constant-current driving elements 550 used in the current regulator IC 450 of the conventional technique are semiconductor elements having a lateral structure (for example, lateral MOSFETs), and the on resistance thereof is higher than that of the vertical element shown in FIG. 3. Therefore, in many cases, the maximum rated voltage thereof is about 45 V (on resistance is several ohms), the maximum rated current thereof is about 50 to 60 mA, and the total LED current which can flow to one current regulator IC 450 is about 900 to 1000 mA.

Since the maximum rated voltage is about 45 V, when variation in the forward voltages V_{F} of the LEDs is taken into consideration, the number of the LEDs connected in series is eight at most, and in the LED array in which the total number of LEDs is 144, the number of the LED strings arranged in parallel is 18. Furthermore, when the LED current is as high as 100 mA, two constant-current driving elements 550 are used in parallel so as to drive the LED string of one channel. Therefore, the numbers of the constant-current driving elements 550 and the constant-current control circuits 650 are 36, respectively, which is obtained by multiplying 18 by two, and two current regulator ICs 450 are required.

FIG. 22 is a graph showing the relation between the LED current per one channel and the mounting area of the current regulator 40 in the conventional technique. As the LED current per channel increases compared with the current state (50 mA/channel), the number of required current regulator ICs 450 increases as described above, and therefore, it can be understood that the mounting area of the current regulator 40 increases.

With respect to such a problem of the increase in the mounting area caused by the increase in the LED current, in the LED driving circuit 1 of the present embodiment, the vertical elements having low on resistance even at a high withstand voltage of 60 V or higher (for example, in a vertical MOSFET, the on resistance is about several tens of milliohms at a size of about 1 mm²) compared with the lateral elements are used as the constant-current driving elements 50 as described above. By this means, in the use for a large panel in which the total number of LEDs is about 80 to 200, the number of LEDs connected in series can be increased to 12 or more and the number of LEDs connected in series can be made larger than the number of LED strings arranged in parallel so as to reduce the number of LED strings arranged in parallel, so that the required number of the constant-current driving elements 50 and the constant-current control circuits 60 can be reduced.

However, since the sum of the forward voltages V_{F} of the LEDs is increased when the number of the LEDs connected in series is increased, the output voltage V_{OUT} of the LED driver 10 of FIG. 1 has to be increased. In this case, generally, in consideration of the variation in the forward voltages V_{F} of the LEDs, the output voltage V_{OUT} is set on the assumption that the LEDs having the highest forward voltage V_{F} are all arranged in series. However, in practice, not all the LEDs arranged in series have the highest forward voltage V_{F}, and therefore, an unnecessarily high voltage is applied to the constant-current driving element 50. As a result, excessive power is consumed at the constant-current driving element 50, and further, load is imposed also on the package 41 and the like due to heat generation. For its prevention, a countermeasure described below is taken in the LED driving circuit 1 of the present embodiment.

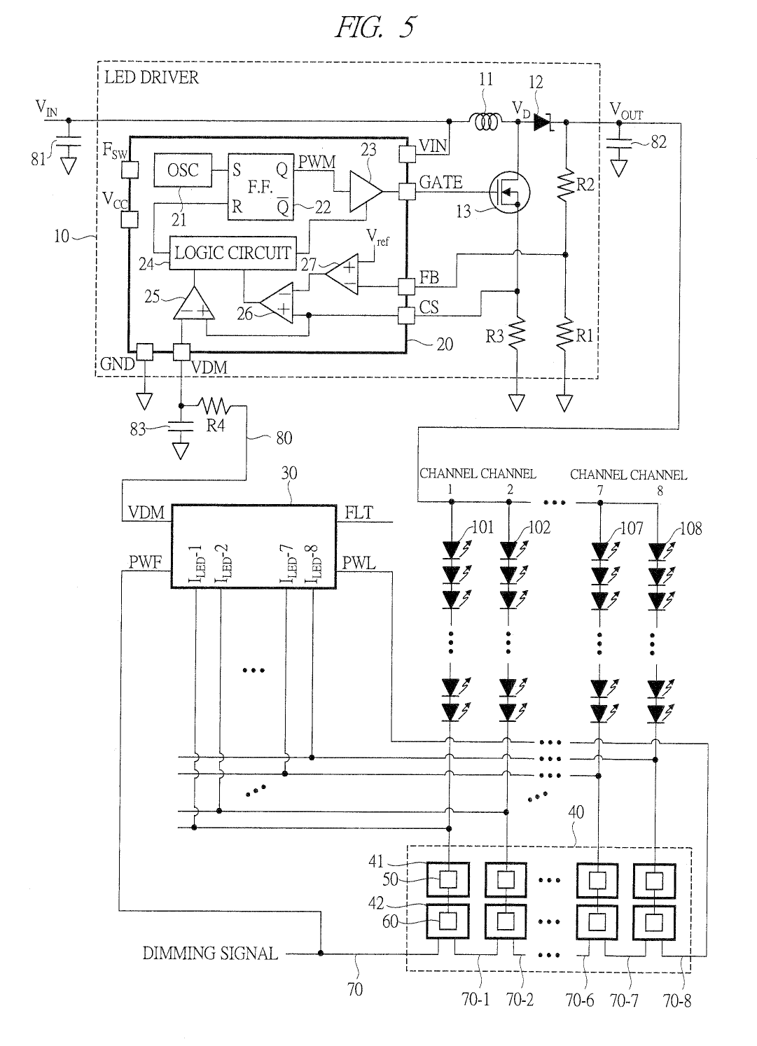

FIG. 5 is a functional block diagram showing a configuration example of the LED driving circuit 1 and a power-supply control circuit 20 shown in FIG. 1. In FIG. 5, the power-supply control circuit 20 is made up of an oscillator (OSC) 21, a flip-flop circuit 22, a driver circuit 23, a logic circuit 24, comparators 25 and 26 and an error amplifier 27. The basic circuit configuration of the LED driver 10 using the power-supply control circuit 20 is the same as a general step-up switching power supply circuit. More specifically, the LED driver 10 is made up of a switching element 13, a choking coil 11, a Schottky diode 12, resistors R1, R2 and R3, and the power-supply control circuit 20. Also, an input capacitor 81 is connected to the input side of the LED driver, and an output capacitor 82 is connected to the output side of the LED driver.

In the LED driver 10, an input voltage V_{IN} is increased by a switching operation of the switching element 13 via the chocking coil 11 and supplied to the LED array 100 as an output voltage V_{OUT} via the Schottky diode 12. The initial set voltage of the output voltage V_{OUT} is set by the resistors R1 and R2. For example, when the reference voltage of a FB terminal of the power-supply control circuit 20 is 1.25 V, the power-supply control circuit 20 controls the on period of the switching element 13 while comparing the FB terminal voltage and the CS terminal (current sense terminal) voltage by the comparator 26 so that V_{OUT} is equal to 1.25×(R1+R2)/R1.

The forward voltage V_{F} of a white LED is, for example, normally 3.4 V and 4.0 V at a maximum with the LED current of 60 mA. Therefore, in the case where the number of the LEDs connected in series is 18, the output voltage V_{OUT} is set to 75 to 80 V in consideration of the worst condition of the variation in the forward voltage V_{F} (the case where the variation is maximum). However, in practice, such a worst condition does not occur. For example, when the forward voltage V_{F} is a normal value of 3.4 V on average, a voltage of 14 to 19 V is unnecessarily applied to the constant-current driving element 50, and a loss of 0.8 to 1.1 W is generated per one constant-current driving element 50 when the LED current is 60 mA. If the LED current is a high current which is equal to 100 mA or higher, the loss is further increased.

In order to prevent this problem, Patent Document 2, Patent Document 3 and the like disclose the methods of detecting the lowest voltage among the terminal voltages of the constant-current driving elements 50 on the LED-string side (in other words, the one at which a highest voltage is applied to the LED string) and lowering the output voltage V_{OUT} of the LED driver 10 until the lowest voltage becomes a lowest voltage required for constant-current drive. However, in these conventional techniques, no consideration is given to the control in the case where the LED current is rapidly changed from a constant current to a zero current or from a zero current to a constant current like in the case of digital dimming.

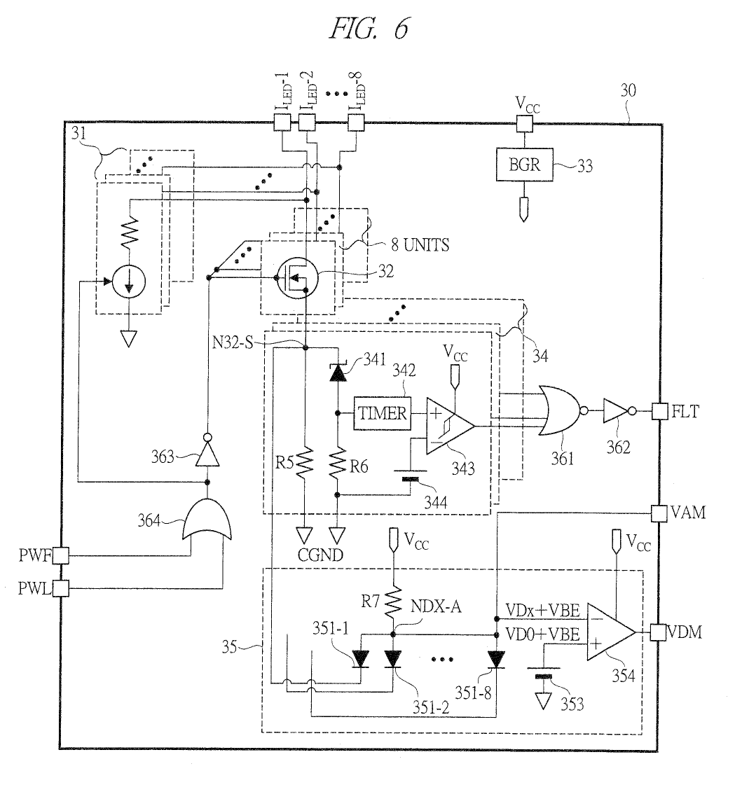

Therefore, the LED driving circuit 1 of the present embodiment has the power-supply control circuit 20 and the lowest-voltage detecting circuit 30 provided in consideration of the control in the case of digital dimming. FIG. 6 is a functional block diagram showing a configuration example of the lowest-voltage detecting circuit 30. In FIG. 6, the lowest-voltage detecting circuit 30 is made up of eight constant-current sources 31, eight dimming-time disconnect switches 32, a bandgap reference power supply (BGR) 33, eight short-circuit detecting circuits 34, a negative OR circuit (NOR) 361 to which the outputs of the short-circuit detecting circuits are inputted, an inverter circuit 362, a lowest-voltage selecting circuit 35, an OR circuit (OR) circuit 364 used for the determination of the dimming state, and an inverter circuit 363.

The lowest-voltage selecting circuit 35 includes eight diodes 351-1 to 351-8, a diode 352, a high resistor R7, an error amplifier 354, and a constant-voltage source 353. Cathodes of the diodes 351-1 to 351-8 are connected to the sources (nodes N32-S) of the dimming-time disconnect switches 32, respectively. Also, anodes of the diodes 351-1 to 351-8 are coupled at a node NDX-A and connected to an inverting input terminal of the error amplifier 354.

The short-circuit detecting circuit 34 includes a Zener diode 341, a timer circuit 342, a comparator 343, a constant-voltage source 344 and resistors R5 and R6, and is disposed between the lowest-voltage selecting circuit 35 and the dimming-time disconnect switches 32 described later. When the voltage of the node N32-S exceeds the Zener voltage of the Zener diode 341, the timer circuit 342 is activated. When the voltage of the node N32-S is higher than the Zener voltage even after predetermined time elapses, the level of the output voltage of the comparator 343 becomes high. As a result, the voltage level of the terminal FLT of the lowest-voltage detecting circuit 30 also becomes high, and an abnormality detection signal indicating that abnormality has been detected can be outputted to a microcomputer (not shown).

In the lowest-voltage detecting circuit 30 of the present embodiment, the terminal voltages of the constant-current driving elements 50 on the LED string side are inputted to terminals I_{LED}-1 to I_{LED}-8, respectively, the lowest voltage VDx among them is selected by the lowest-voltage selecting circuit 35, and a voltage VDx+VBE (VBE is a forward voltage of the diode) is inputted to the inverting input terminal of the error amplifier 354. A voltage VD0+VBE (VD0 is the lowest voltage required for constant-current drive) is inputted to a non-inverting input terminal of the error amplifier 354, and the difference between VDx and VD0 is amplified and outputted from a terminal VDM as a command signal 80 to the power-supply control circuit 20.

In FIG. 5, when the LED driver 10 is activated, the power-supply control circuit 20 increases the voltage of the output voltage V_{OUT} in accordance with the initial set voltage, and after a predetermined period of time elapses, the power-supply control circuit 20 switches the loop of feedback control to control the output voltage in accordance with the voltage of the command signal 80. More specifically, the power-supply control circuit 20 controls the on period of the switching element 13 while comparing the VDM terminal voltage with the CS terminal (current sense terminal) voltage by the comparator 25. As a result, the lowest voltage VDx in FIG. 6 is controlled so as to be equal to the lowest voltage VD0 required for the constant-current drive. Herein, a resistor R4 and a capacitor 83 in FIG. 5 have a function of extending the time constant of change of the VDM signal so as to be longer than a switching cycle in order to stabilize the feedback control of the LED driver 10.

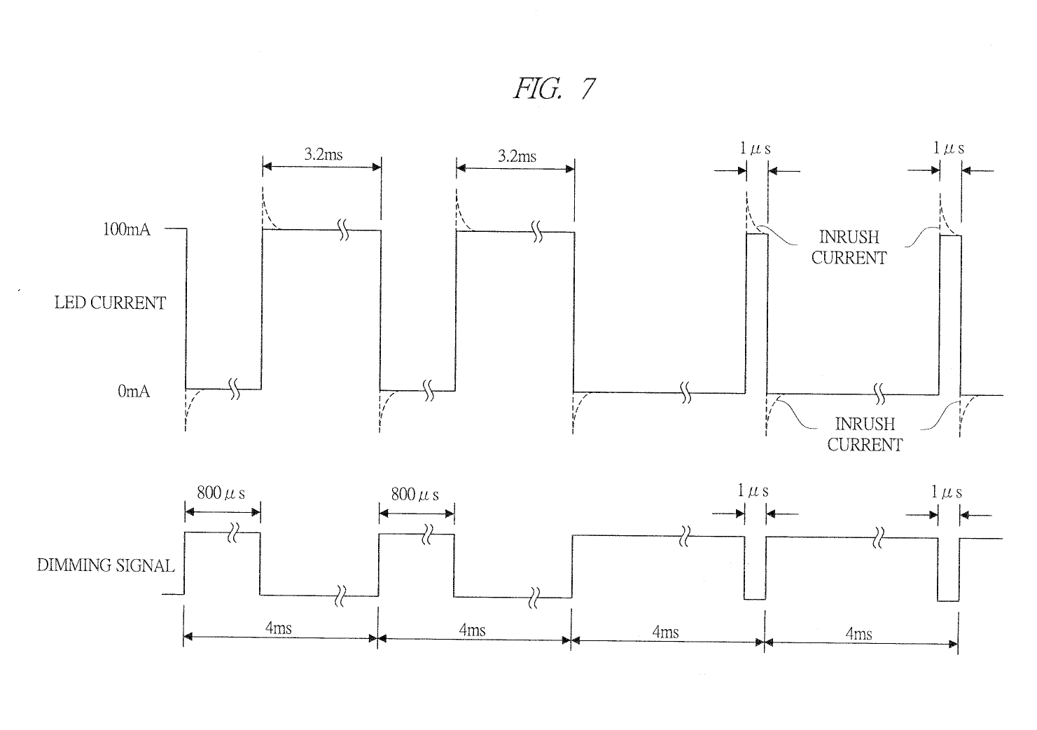

The control as described above has no problem in the case of normal operations. However, a problem below occurs when digital dimming is carried out. FIG. 7 is a drawing showing an example of the operation waveforms of the LED current and the dimming signal in digital dimming. As shown in FIG. 7, when the signal level of the dimming signal is a low level, a constant current (for example, 100 mA in the present embodiment) flows to the LEDs, and when it is a high level, the LED current is 0 mA.

Since no current flows to the LEDs during the period in which the dimming signal is the high level, the voltages of the terminals I_{LED}-1 to I_{LED}-8 of the lowest-voltage detecting circuit 30 become approximately equal to the output voltage V_{OUT}/and the output signal VDM is maintained at a highest voltage level. Therefore, when the control of “high dimming ratio” in which almost all the period of the dimming cycle is occupied by the state where the LED current is 0 mA is continued for a long period of time, the output voltage V_{OUT} is significantly reduced. Therefore, the time taken until the LED current returns to a constant-current state of 100 mA becomes long, and a high dimming ratio cannot be maintained.

Therefore, in the present embodiment, in the lowest-voltage detecting circuit 30, the connection between the lowest-voltage selecting circuit 35 and the LED array 100 is disconnected when the signal level of the dimming signal is the high level. In other words, the input of the terminal voltages (the voltages of the terminals I_{LED}-1 to I_{LED}-8) of the constant-current driving elements 50 on the LED string side to the lowest-voltage selecting circuit 35 is disconnected. For this purpose, the OR circuit (OR) 364 used for the determination of the dimming state, the inverter circuit 363 and the dimming-time disconnect switch 32 are provided.

In this manner, the output voltage of the lowest-voltage detecting circuit 30 is maintained at the voltage of the point immediately before the dimming signal becomes the high level, and the output voltage of the terminal VDM is also maintained by the capacitor 83 of FIG. 5, so that almost no reduction occurs in the output voltage V. Moreover, since the voltages of the terminals I_{LED}-1 to I_{LED}-8 are not inputted also to the short-circuit detecting circuits 34 when the signal level of the dimming signal is the high level, malfunction of the short-circuit detecting circuits 34 is not caused.

The eight constant-current sources 31 in the lowest-voltage detecting circuit 30 are provided for the purpose of, when the signal level of the dimming signal is the high level, supplying a minute current (μA order) of the degree that does not cause the light emission to the LED strings so as to control the voltages of the terminals I_{LED}-1 to I_{LED}-8 to be constant at ten and several volts. By this means, even when the output voltage V_{OUT} is a high voltage, the amount of change in the voltages of the terminals I_{LED})-1 to I_{LED}-8 in dimming is reduced, and therefore, switching between on (100 mA) and off (0 mA) of the LED current is speeded up and a high dimming ratio can be maintained. Note that Zener diodes having Zener voltages of ten and several volts can be used instead of the constant-current sources 31. This is the same also in the subsequent embodiments.

Next, a prevention measure against the inrush current in digital dimming which is another problem caused by the increase of the LED current will be described. As shown in FIG. 7 above, the LED current is rapidly changed when the dimming signal is switched from the high level to the low level or from the low level to the high level. Therefore, resonant oscillation occurs due to the parasitic inductance or the parasitic capacitance of wiring and the inrush currents as shown in the drawing are generated, so that noise and flickering are caused. The noise and flickering can be reduced by changing the switching timing of the dimming signal with respect to the LED strings little by little so as to mutually shift the timings at which the LED current is rapidly changed among the LED strings.

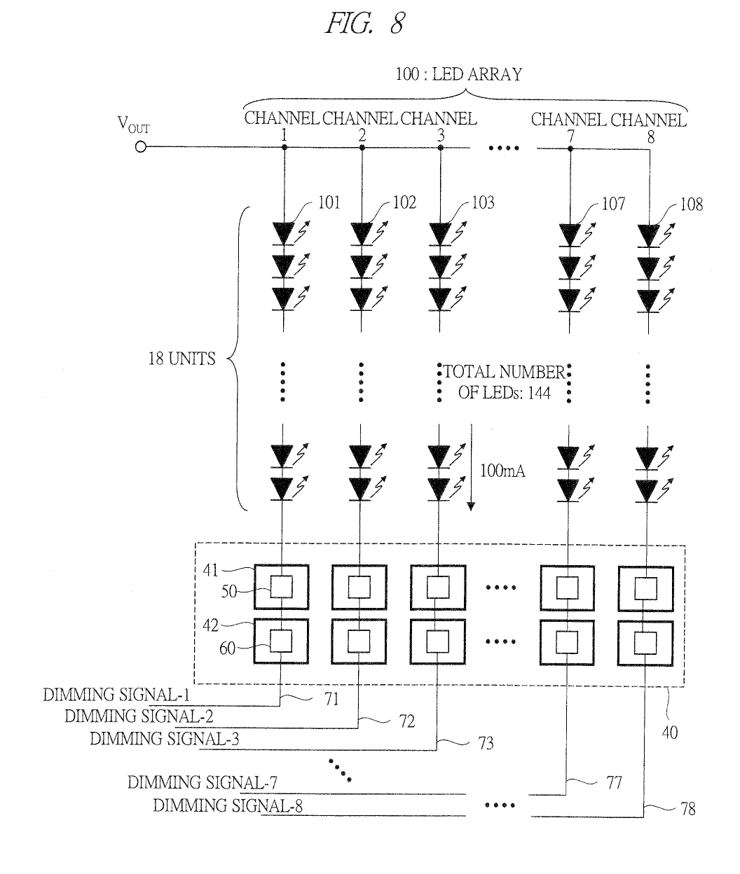

However, when this is carried out by the transmission means of the dimming signal according to a conventional technique, the dimming signal wiring is increased. FIG. 8 is a functional block diagram showing a configuration example of the LED array 100 and the current regulator 40 in the case where the dimming signal wiring according to the conventional technique is used. As shown in FIG. 8, eight lines of dimming signal wirings 71 to 78 are required in order to input the dimming signals to the above-described eight constant-current control circuits 60 at mutually shifted timings. As a result, a large wiring area is required on a printed board, the circuit scale of microcomputers (not shown) for generating the signals at mutually shifted timings is increased, and the mounting area is also increased. Furthermore, also when the frequency of dimming is adjusted by a user so as to optimize it as a system applying LEDs, the labor for changing the frequency and timing is increased.

Therefore, in the present embodiment, as shown in FIG. 4, the dimming signal is inputted from the terminal PWM_{IN} to the constant-current control circuit 60, which controls the current of the LED string 101, via the dimming signal wiring 70. The inputted dimming signal is delayed by the internal delay circuit 65 and then outputted by the drive circuit 64 from the terminal PWM_{OUT}. The outputted dimming signal is inputted to another constant-current control circuit 60, which controls the current of the next LED string 102, via the dimming signal wiring 70-1. The inputted dimming signal is similarly delayed by the internal delay circuit 65 and sequentially transmitted to the constant-current control circuit 60 of the next stage.

As a result, the region corresponding to one line of the dimming signal will suffice for the wiring area of the dimming signal, and the number of dimming signals which a microcomputer is required to generate is only one. Note that the transmission method of the dimming signal shown here can be applied not only to the current regulator 40 of the present embodiment but also to the current regulator IC 450 according to the conventional technique shown in FIG. 21.

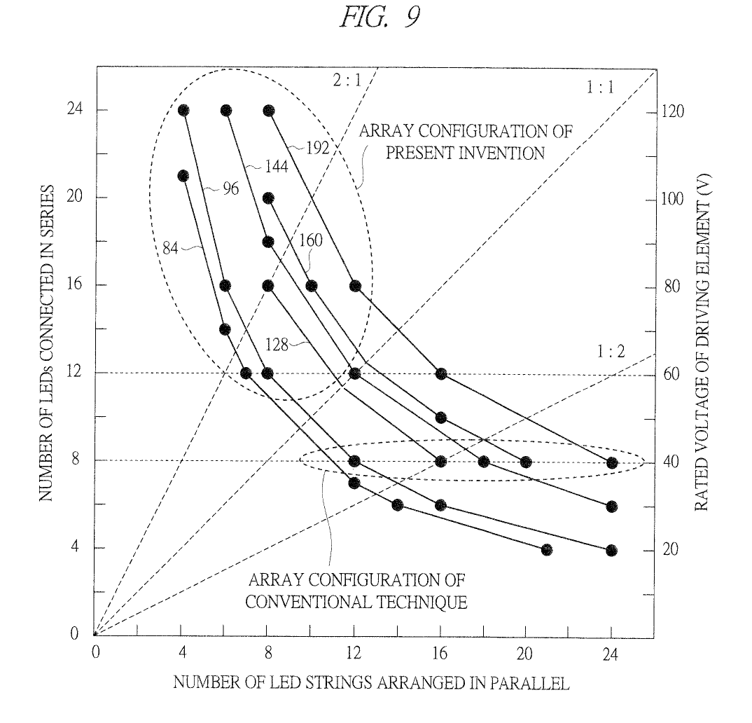

FIG. 9 is a graph showing the relation between the number of the LEDs connected in series and the number of the LED strings arranged in parallel in the LED array 100 and the rated voltages of the constant-current driving elements 50. In the LED driving circuit 1 of the present embodiment, as shown in FIG. 9, in the use for a large panel in which the total number of LEDs is about 80 to 200, the number of the LEDs connected in series can be made larger than the number of the LED strings arranged in parallel (upper left area of a broken line of 1:1 in the drawing). More specifically, the number of the LEDs connected in series can be increased to 12 or more so as to reduce the number of the LED strings arranged in parallel, and the required number of the constant-current driving elements 50 and the constant-current control circuits 60 can be reduced. As a result, the effect of reducing the output current of the LED driver 10 can be also obtained.

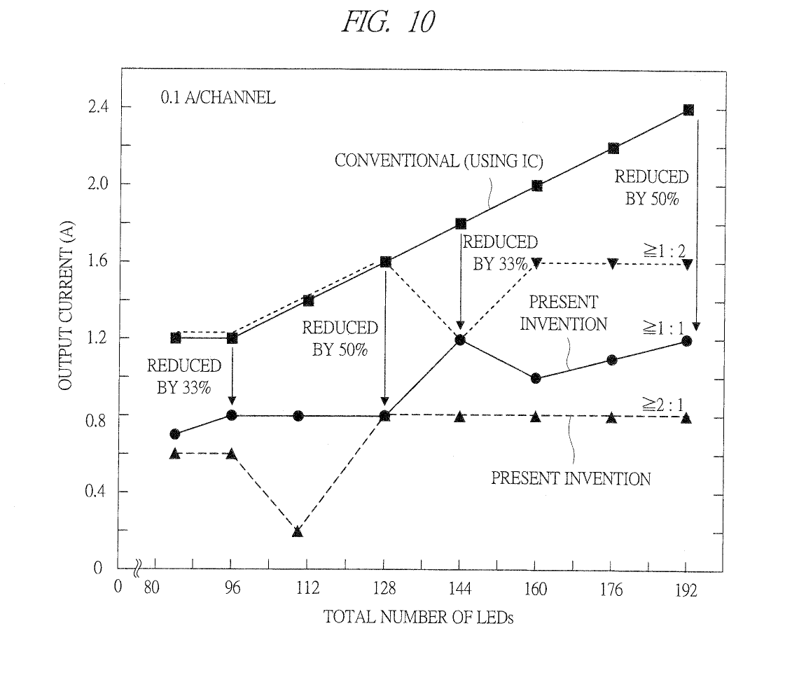

FIG. 10 is a graph showing the relation between the output currents and the total number of LEDs in the LED driving circuits of the conventional technique and the present embodiment. FIG. 10 shows the relation between the output currents and the total number of LEDs in the case where the LED current per one channel is 0.1 A. When the number of the LEDs connected in series is equal to or larger than the number of the LED strings arranged in parallel (upper left area of the broken line of 1:1 in FIG. 9), the output current can be reduced by 50 to 33% compared with the conventional technique using the current regulator IC 450. By this means, the power consumption of the Schottky diode 12 of FIG. 1 can be also reduced by 50 to 33%, and the generation amount (frequency) of noise in digital dimming can be reduced because the total current flowing through the LED array 100 is reduced.

As described above, in the LED driving circuit 1 according to the present embodiment, the number of the elements (the constant-current driving elements 50 and the constant-current control circuits 60) for driving the LEDs with a constant current can be reduced, and the increase in the mounting area can be suppressed even when a high current flows to the LEDs.

Moreover, not only in stationary operations but also in digital dimming, the voltage applied to the LEDs can be appropriately controlled, and the loss and heat generation at the constant-current driving elements 50 can be reduced. Moreover, since the total current that flows to the LED array 100 can be reduced, the amount of the noise generated in digital dimming can be reduced.

Furthermore, since the inrush current to the LED array 100 generated in digital dimming can be suppressed with a little dimming signal wiring, the dimming signal wiring area can be reduced. Moreover, since the dimming signal can be readily generated, the load applied to a microcomputer or the like which generates the dimming signal can be reduced, so that the increase in the circuit scale can be suppressed.

### Second Embodiment

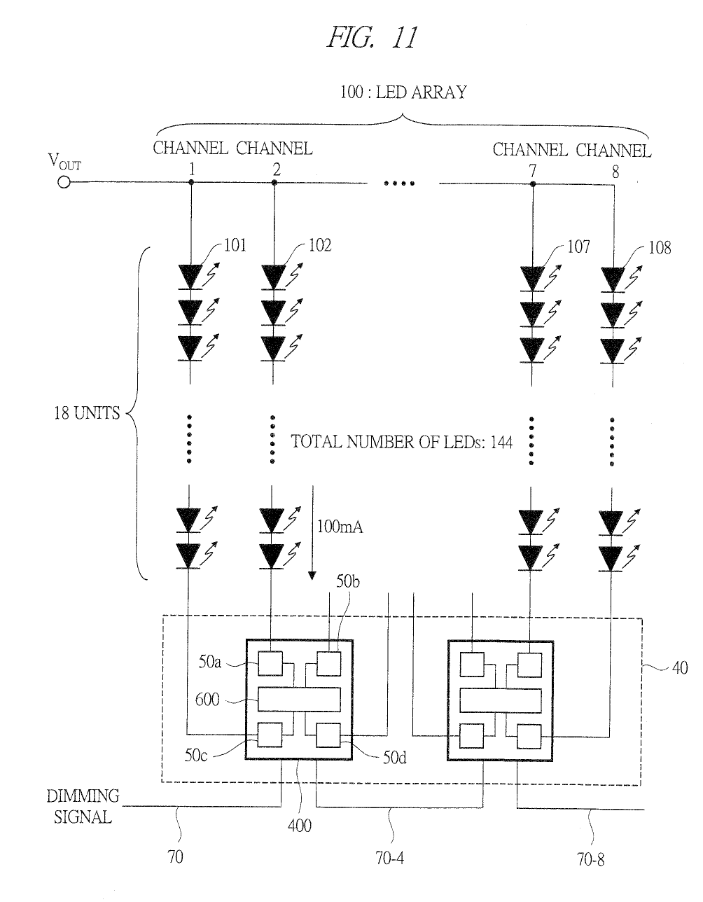

Hereinafter, an LED driving circuit according to a second embodiment of the present invention will be described with reference to FIG. 11 to FIG. 13. FIG. 11 is a functional block diagram showing a configuration example of the LED array 100 and the current regulator 40 in the LED driving circuit according to the second embodiment of the present invention. The point different from the current regulator 40 of the first embodiment shown in FIG. 2 is that a plurality (four in this embodiment) of constant-current driving elements 50 (50a to 50d) for driving a channel with a constant current and a constant-current control circuit 600 which controls the elements so as to carry out constant-current drive are mounted in one package 400.

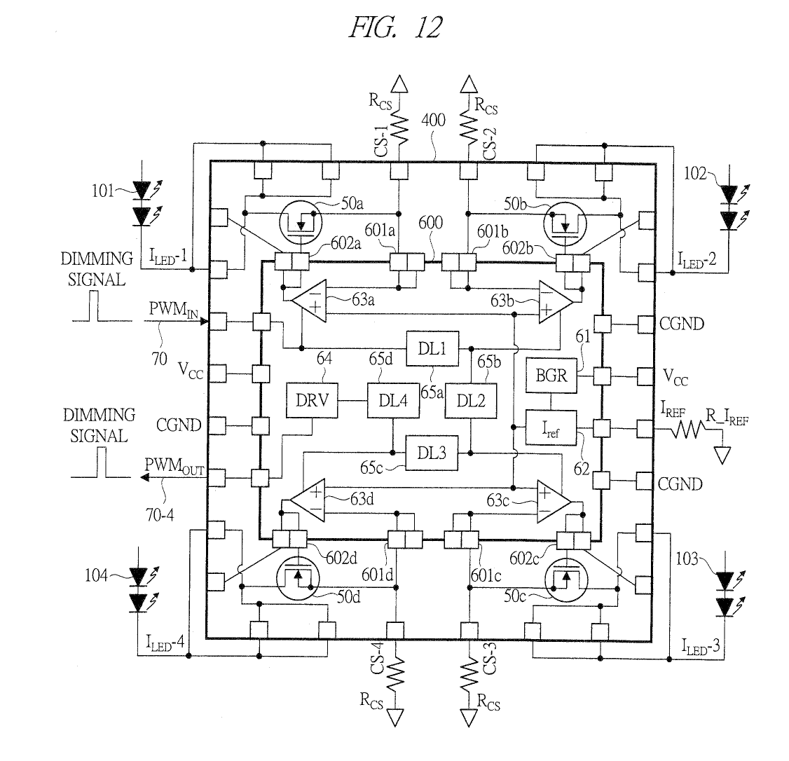

FIG. 12 is a functional block diagram showing a circuit configuration and a configuration example of a package in the case where the plurality of constant-current driving elements 50a to 50d and the constant-current control circuit 600 are mounted in the one package 400. In the package 400, five semiconductor elements in total, that is, the four constant-current driving elements 50a to 50d and the constant-current control circuit 600 which controls the elements so as to carry out constant-current drive are incorporated. The constant-current control circuit 600 corresponds to the integration of four constant-current control circuits 60 shown in FIG. 4 of the first embodiment and is a semiconductor element (semiconductor integrated circuit) incorporating the bandgap reference power supply (BGR) 61, the voltage level shift element (Iref) 62 for LED current setting, four operational amplifiers 63a to 63d, four delay circuits 65a to 65d which delay inputted dimming signals, and a drive circuit (DRV) 64 which outputs the delayed dimming signals.

The dimming signal is inputted to the constant-current control circuit 600 from the terminal PWM_{IN} via the dimming signal wiring 70 and inputted to the operational amplifier 63a and the delay circuit 65a. The operational amplifier 63a turns on (constant-current state) or turns off (current zero state) the constant-current driving element 50a in accordance with the dimming signal. The dimming signal delayed by the delay circuit 65a is inputted to the operational amplifier 63b and the delay circuit 65b. The operational amplifier 63b turns on or turns off the constant-current driving element 50b in accordance with the dimming signal. The dimming signal delayed by the delay circuit 65b is inputted to the operational amplifier 63c and the delay circuit 65c. The operational amplifier 63c turns on or turns off the constant-current driving element 50c in accordance with the dimming signal. The dimming signal delayed by the delay circuit 65c is inputted to the operational amplifier 63d and the delay circuit 65d. The operational amplifier 63d turns on or turns off the constant-current driving element 50d in accordance with the dimming signal.

The dimming signal delayed by the delay circuit 65d is outputted from the terminal PWM_{OUT} by the drive circuit 64 and inputted to another constant-current control circuit 600, which controls the current of the next LED string 105, via a dimming signal wiring 70-4. The inputted dimming signal is similarly delayed therein and sequentially transmitted to the constant-current control circuit 600 of the next stage. In this manner, similarly to the first embodiment, the region corresponding to one line of the dimming signal will suffice for the wiring area of the dimming signal, and the number of dimming signals which a microcomputer is required to generate is only one. Note that the description of the operation for the constant-current control of the LED current will be omitted because the contents thereof are the same as those described in the first embodiment.

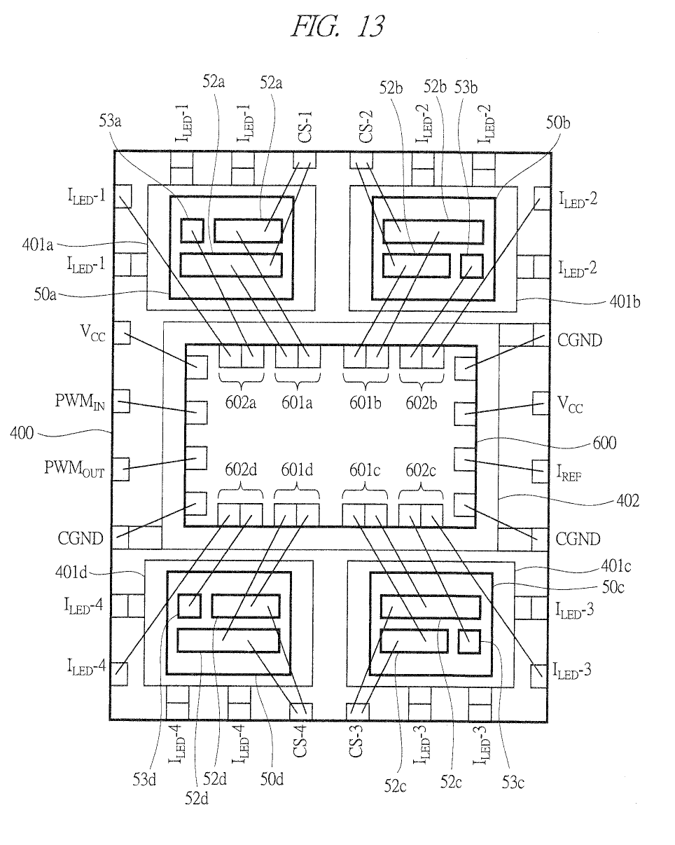

FIG. 13 is a drawing showing an example of a mounting state of the package 400 of FIG. 12. The four constant-current driving elements 50a to 50d are n-channel vertical MOSFETs shown in FIG. 3 of the first embodiment and electrically connected onto lead frames 401a to 401d, respectively. More specifically, the drain electrodes of the n-channel vertical MOSFETs (although not shown in FIG. 13, formed on the back surfaces of the constant-current driving elements 50a to 50d, respectively, as shown in FIG. 3) are connected to the lead frames 401a to 401d, respectively, via a die bonding material such as silver paste. Also, the constant-current control circuit 600 is electrically connected onto a lead frame 402.

The lead frames 401a to 401d are connected to metal thin-film wirings and metal thin-film pads (not shown), which are connected to the LED strings 101 to 104 of FIG. 12, on a printed board (not shown) via the terminals I_{LED}-1 to I_{LED}-4 and the lead frames 401a to 401d themselves exposed from the back surface of the package 400. Also, the lead frame 402 is connected to metal thin-film wirings and metal thin-film pads (not shown) fixed to the ground potential on the printed board (not shown) via a terminal CGND and the lead frame 402 itself exposed from the back surface of the package 400.

Source electrode pads 52a and a gate electrode pad 53a are formed on the surface of the constant-current driving element 50a and respectively connected to electrode pads 601a and 602a on the constant-current control circuit 600 by metal wires. In this case, as shown in FIG. 12, the electrode pads 601a and 602a are respectively connected to an inverting input terminal of the operational amplifier 63a and an output terminal of the operational amplifier 63a by metal thin-film wiring in the element. The other constant-current driving elements 50b to 50d are also wired in the same manner as the constant-current driving element 50a.

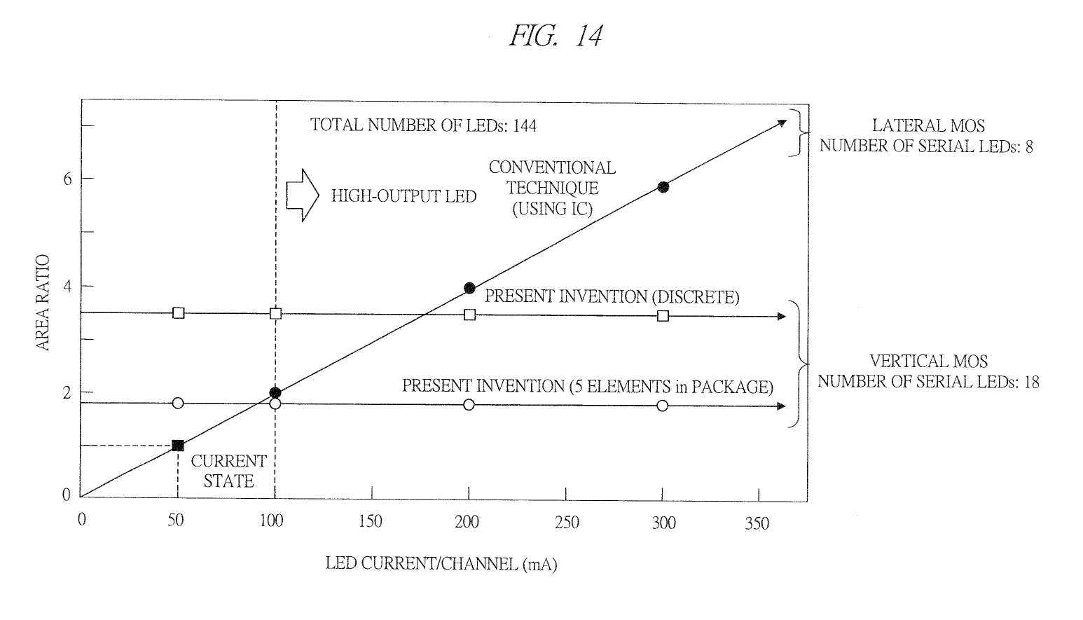

FIG. 14 is a graph showing the relation between the LED current per one channel and the mounting area of the current regulator in the LED driving circuits in the conventional technique and the first and second embodiments. When the current regulator IC 450 according to the conventional technique shown in FIG. 21 is used, like the case shown in FIG. 22, the LED current per one channel in the current state is about 50 mA, and the mounting area increases in proportion to the increase in the LED current.

On the other hand, when the current regulators 40 (FIG. 2 and FIG. 11) in the LED driving circuits 1 of the first and second embodiments are used, vertical elements having a low on resistance even at a high withstand voltage can be used, and the number of elements for driving the LEDs with a constant current can be reduced, so that the mounting area almost equivalent to that of the case of 50 mA can be maintained even when the LED current per one channel becomes as high as about 350 mA. Moreover, the mounting area can be further reduced when five semiconductor elements are integrated in the package 400 like in the present embodiment.

As described above, in the LED driving circuit 1 according to the present embodiment, the plurality of constant-current driving elements 50a to 50d and the constant-current control circuit 600, which controls the elements so as to carry out constant-current drive, are mounted in the one package 400, so that a part of the configuration of the constant-current control circuit 600 can be shared by the plurality of constant-current driving elements 50. Therefore, the mounting area can be further reduced.

### Third Embodiment

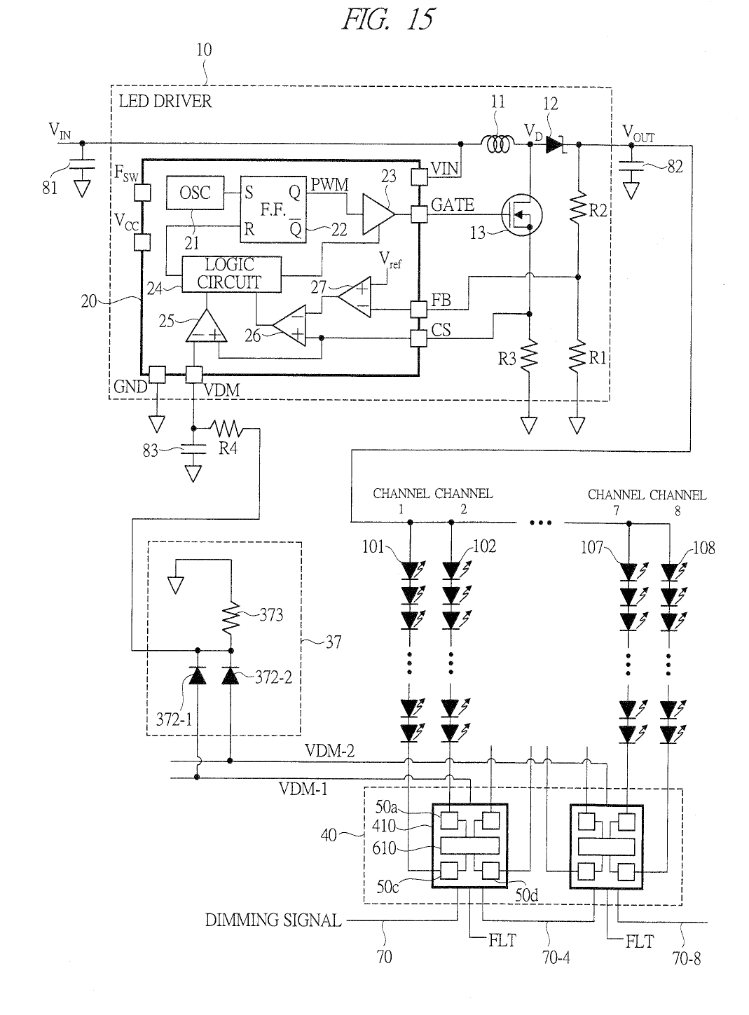

Hereinafter, an LED driving circuit according to a third embodiment of the present invention will be described with reference to FIG. 15 to FIG. 18. FIG. 15 is a functional block diagram showing a configuration example of the LED driving circuit 1 according to the third embodiment of the present invention. The point different from the configuration examples of the first and second embodiments is that the lowest-voltage detecting circuit 30 is incorporated in a constant-current control circuit 610 as described later. In this configuration, the constant-current control circuit 610 detects the smallest value of the drain voltages of the four constant-current driving elements 50a to 50d incorporated in a package 410 and outputs a command signal from a terminal VDM of each package. Accordingly, a command-signal selecting circuit 37 which selects the highest voltage from the command signals (VDM-1 and VDM-2 in the drawing) outputted from the packages 410 is provided, and this is another different point.

The command-signal selecting circuit 37 is made up of two diodes 372-1 and 372-2 and a resistor 373. The anodes of the diodes 372-1 and 372-2 (output of the command-signal selecting circuit 37) coupled to the same node are connected to the terminal VDM of the power-supply control circuit 20 via the resistor R4 and the capacitor 83.

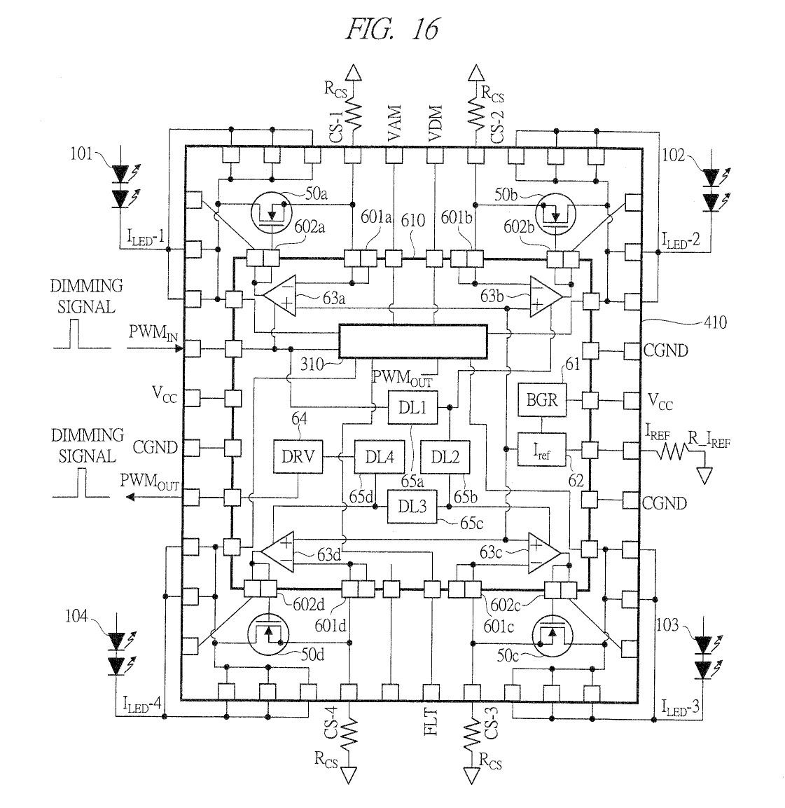

FIG. 16 is a functional block diagram showing a circuit configuration and a configuration example of a package in the case where the plurality of constant-current driving elements 50a to 50d and the constant-current control circuit 610 are mounted in the one package 410. The point different from the configuration example of the second embodiment shown in FIG. 12 is that a lowest-voltage detecting circuit 310 is incorporated in the constant-current control circuit 610. Accordingly, the output terminal VDM of the command signal, a compensating circuit connecting terminal VAN of an error amplifier, and an output terminal FLT of an abnormality detection signal are provided.

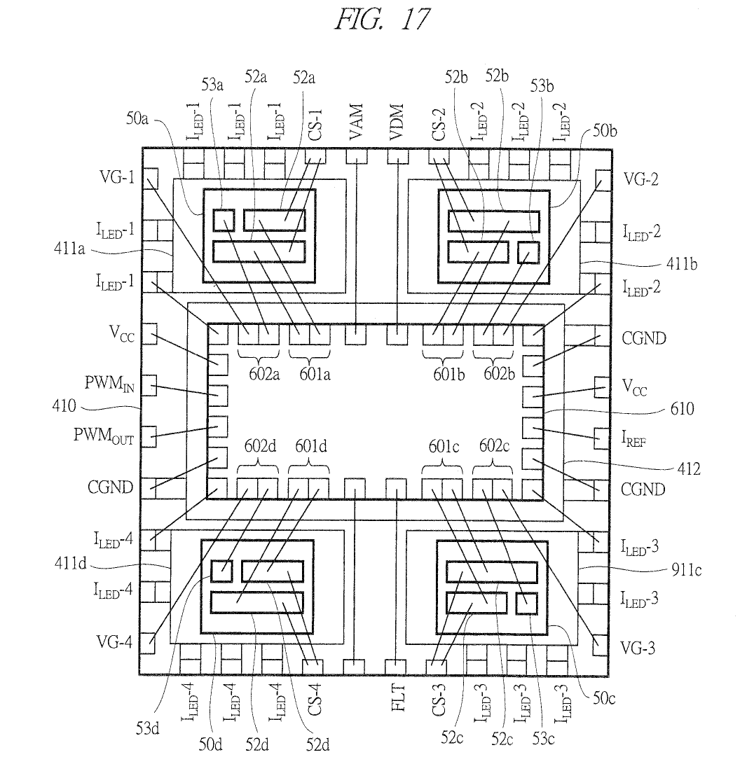

FIG. 17 is a drawing showing an example of the mounting state of the package 410 of FIG. 16. When compared with the example of the mounting state shown in FIG. 13 of the second embodiment, this example is basically the same except the above-described newly added terminals, pads newly added onto the constant-current control circuit 610, and gold wires connecting them.

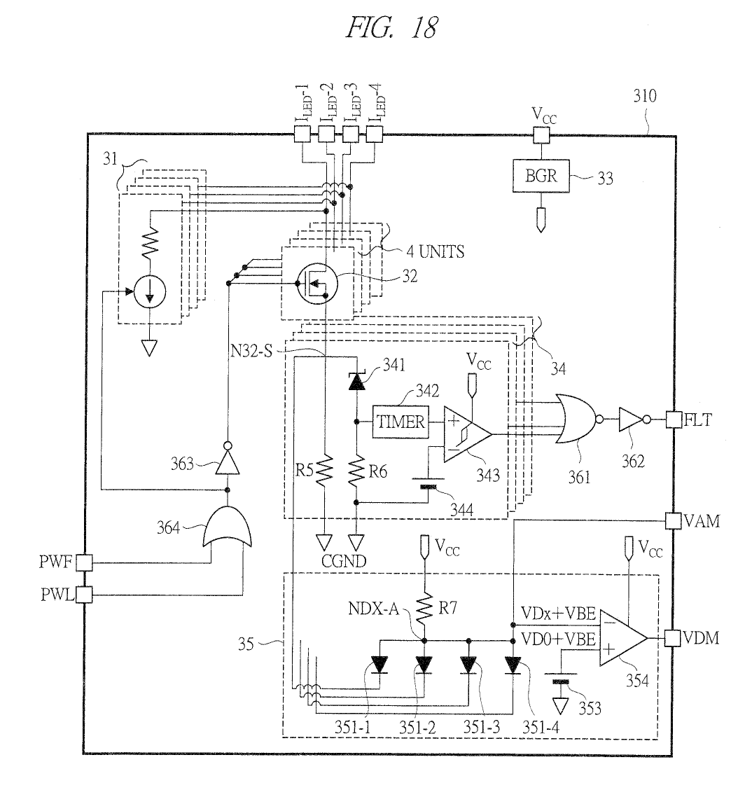

FIG. 18 is a functional block diagram showing an example of the circuit configuration of the lowest-voltage detecting circuit 310. The point different from the lowest-voltage detecting circuit 30 of the first embodiment shown in FIG. 6 is that the number of detections of the terminal voltages of the constant-current driving elements 50 is four (I_{LED}-1 to I_{LED}-4) so as to correspond to the number of the LED strings controlled with a constant current by the package 410. Accordingly, the number of the dimming-time disconnect switches 32, the diodes 351-1 to 351-4 of the lowest-voltage selecting circuit 35, the short-circuit detecting circuits 34, and the constant-current sources 31 is also changed to four, respectively. Except these points, the circuit configuration and the operations thereof are the same as those of the lowest-voltage detecting circuit 30 of the first embodiment shown in FIG. 6.

As described above, in the LED driving circuit 1 according to the present embodiment, the plurality of constant-current driving elements 50a to 50d and the constant-current control circuit 610, which controls the elements so as to carry out constant-current control, are mounted in the one package 410 and further the lowest-voltage control circuit 310 is incorporated in the current-control circuit 610, and, as a result, the mounting of the LED driving circuit 1 can be facilitated.

### Fourth Embodiment

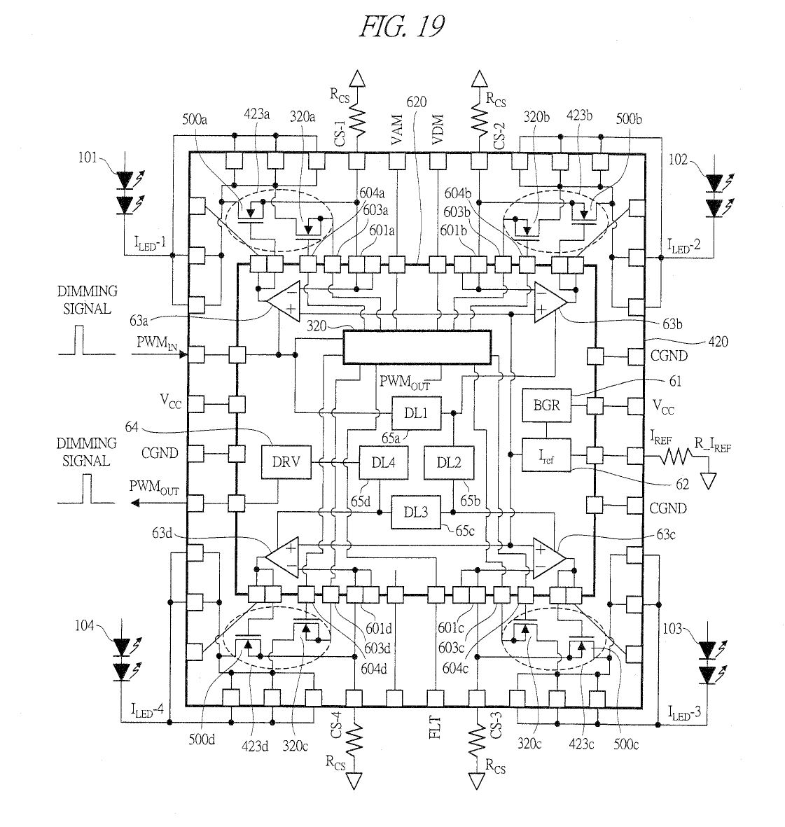

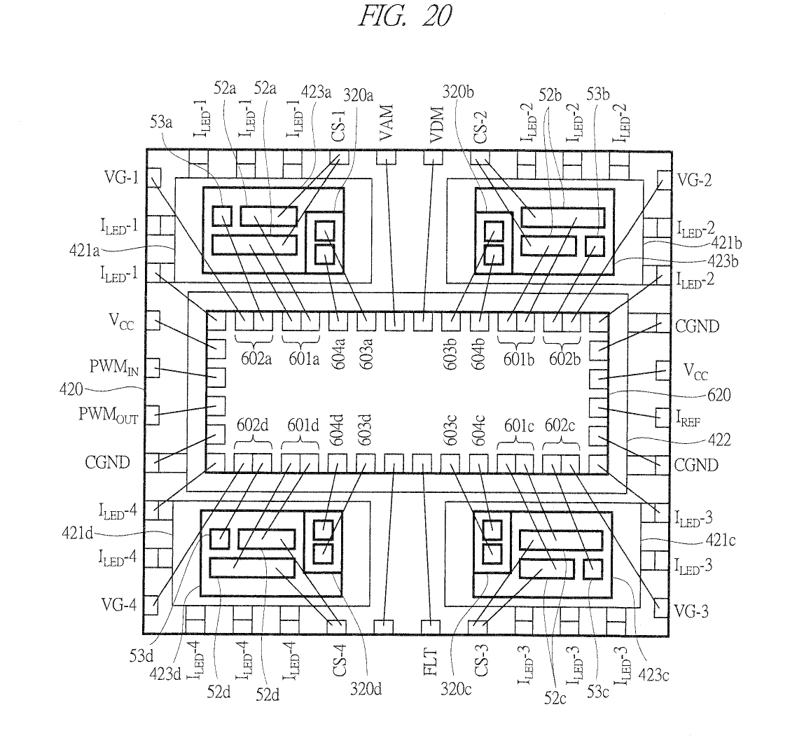

Hereinafter, an LED driving circuit according to a fourth embodiment of the present invention will be described with reference to FIG. 19 to FIG. 20. FIG. 19 is a functional block diagram showing a circuit configuration and a configuration example of a package in the case where the plurality of constant-current driving elements 500a to 500d and the constant-current control circuit 620 are mounted in the one package 420. The point different from the configuration example of the third embodiment shown in FIG. 16 is that a part corresponding to the dimming-time disconnect switches 32 in the lowest-voltage detecting circuit 320 of FIG. 16 is incorporated in a part of the constant-current driving elements 500a to 500d and the other part is incorporated in the constant-current control circuit 620 as the lowest-voltage detecting circuit 320.

In FIG. 19, the constant-current driving elements 500a to 500d correspond to the constant-current driving elements 50a to 50d of FIG. 16, and dimming-time disconnect switches 320a to 320d correspond to the dimming-time disconnect switches 32 of FIG. 18. Hereinafter, the configurations of the constant-current driving element 500a and the dimming-time disconnect switch 320a will be described. Note that the other constant-current driving elements 500b to 500d and the dimming-time disconnect switches 320b to 320d also have the same configurations.

The dimming-time disconnect switch 320a is constituted as an n-channel vertical MOSFET similarly to the constant-current driving element 500a. The MOSFETs constituting the constant-current driving element 500a and the dimming-time disconnect switch 320a individually have gate electrodes and source electrodes, but share a drain electrode, and they are formed on one chip and mounted in the package 420 as an n-channel vertical MOSFET 423a.

FIG. 20 is a drawing showing an example of the mounting state of the package 420 of FIG. 19. A source electrode pad and a gate electrode pad of the dimming-time disconnect switch 320a are respectively connected to pads 603a and 604a on the constant-current control circuit 620 via gold wires. Since the constant-current driving element 500a and the dimming-time disconnect switch 320a have different source potentials at the operation, the source regions thereof are mutually separated in potential by a diffusion layer in the chip.

As described above, in the LED driving circuit 1 according to the present embodiment, the withstand voltage of the constant-current control circuit 620 can be reduced by mounting the dimming-time disconnect switches 320a to 320d, which are formed of MOSFETs having a high withstand voltage, outside the constant-current control circuit 620 so as to be incorporated in the MOSFETs of the constant-current driving elements 500a to 500d.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, as shown in FIG. 1, FIG. 5 and FIG. 15, in the LED driving circuits 1 of the first to fourth embodiments, the LED driver 10 is a step-up switching power supply circuit. However, similar effects can be obtained even when the driver is a step-down switching power supply circuit or a step-up/down switching power supply circuit depending on the magnitude of the input voltage V_{IN}. Also, as shown in FIG. 3, the constant-current driving element 50 is the vertical MOSFET in the LED driving circuits 1 of the first to fourth embodiments. However, it goes without saying that the element may be a vertical bipolar transistor. Furthermore, the LED driving circuits 1 of the second to fourth embodiments have the configuration in which the constant-current driving elements corresponding to four channels and the chip of the constant-current control circuit thereof are integrated in one package. However, the number of channels to be driven with a constant current and the number of chips to be integrated are not limited to those, and various modifications can be made therein.

The LED driving circuit of the present invention is effective in the case where an array of a large number of LEDs arranged in series and in parallel is driven so that a uniform constant current flows thereto, and the LED driving circuit can be utilized in power supply circuits of LED backlights, large LED lighting and the like for use in liquid crystal displays of liquid crystal TVs, PCs and others.

What is claimed is:

1. An LED driving circuit driving an LED array in which n LED strings in each of which m LEDs are connected in series are arranged in parallel, the LED driving circuit comprising:
n first semiconductor elements having a vertical structure, each of which is connected to each of the LED strings in series and drives the LED string with a constant current;
n constant-current control circuits controlling on voltages of the first semiconductor elements so that currents flowing to the LED strings become constant currents;
a lowest-voltage detecting circuit to which terminal voltages of the first semiconductor elements on an LED string side are inputted, the lowest-voltage detecting circuit selecting a lowest voltage from among the terminal voltages and outputting a command signal based on difference between the lowest voltage and a predetermined set voltage; and
a power-supply control circuit controlling a voltage applied to the LED array to a voltage lower than an initial set voltage based on the command signal from the lowest-voltage detecting circuit.

2. The LED driving circuit according to claim 1, wherein
the lowest-voltage detecting circuit includes:
a lowest-voltage selecting circuit selecting a lowest voltage from among the inputted terminal voltages; and
dimming-time disconnect switches disconnecting input of the terminal voltages to the lowest-voltage selecting circuit when the first semiconductor elements are in an off state or in a state close to an off state by an inputted digital dimming signal.

3. The LED driving circuit according to claim 2, wherein
the lowest-voltage detecting circuit has constant-current sources which supply minute currents of a degree which does not cause light emission to the respective LED strings when the first semiconductor elements are in an off state or in a state close to an off state by the digital dimming signal.

4. The LED driving circuit according to claim 2, wherein
the lowest-voltage detecting circuit has short-circuit detecting circuits, which output an abnormality detection signal when any of the inputted terminal voltages is higher than a predetermined voltage even after predetermined time elapses, between the dimming-time disconnect switches and the lowest-voltage selecting circuit.

5. The LED driving circuit according to claim 1, wherein
the constant-current control circuit has a delay circuit delaying an inputted digital dimming signal, outputs the digital dimming signal delayed by the delay circuit, and inputs the digital dimming signal to the constant-current control circuit of a next stage.

6. The LED driving circuit according to claim 1, wherein
the power-supply control circuit sets a voltage applied to the LED array to the initial set voltage immediately after activation, and after predetermined time elapses from the activation, the power-supply control circuit controls the voltage applied to the LED array to a voltage lower than the initial set voltage based on the command signal from the lowest-voltage detecting circuit.

7. The LED driving circuit according to claim 1, wherein
the number m of the LEDs connected in series and the number n of the LED strings arranged in parallel in the LED array to be driven satisfy a condition of m>n.

8. The LED driving circuit according to claim 1, wherein
the number m of the LEDs connected in series in the LED array to be driven is equal to or larger than 12, and a constant current flowing to each of the LED strings in the LED array is 100 mA or higher.

9. A second semiconductor element used in the LED driving circuit according to claim 1, wherein
the constant-current control circuits in the LED driving circuit are integrated on one chip.

10. A third semiconductor element used in the LED driving circuit according to claim 1, wherein
a plurality of the constant-current control circuits in the LED driving circuit are integrated on one chip.

11. A fourth semiconductor element used in the LED driving circuit according to claim 1, wherein
the third semiconductor element according to claim 10 and the first semiconductor elements of the same number as the number of the constant-current control circuits integrated in the third semiconductor element are integrated in one package.

12. A fifth semiconductor element used in the LED driving circuit according to claim 1, wherein
the third semiconductor element according to claim 10 and the lowest-voltage detecting circuit are integrated on one chip.

13. A sixth semiconductor element used in the LED driving circuit according to claim 1, wherein
the fifth semiconductor element according to claim 12 and the first semiconductor elements of the same number as the number of the constant-current control circuits integrated in the fifth semiconductor element are integrated in one package.

14. A seventh semiconductor element used in the LED driving circuit according to claim 2, wherein
the third semiconductor element according to claim 10 and a part of the lowest-voltage detecting circuit except the dimming-time disconnect switches are integrated on one chip.

15. An eighth semiconductor element used in the LED driving circuit according to claim 2, wherein
the seventh semiconductor element according to claim 14 and the first semiconductor elements of the same number as the number of the constant-current control circuits integrated in the seventh semiconductor element are integrated in one package, and the dimming-time disconnect switches in the lowest-voltage detecting circuit are incorporated in each part of the first semiconductor elements.

16. An LED driving circuit driving an LED array in which n LED strings in each of which m LEDs are connected in series are arranged in parallel, the LED driving circuit comprising:
a plurality of ninth elements which are the semiconductor elements according to claim 12 to which the LED strings of the same number as the number of the constant-current control circuits integrated in the semiconductor elements are connected; and
a command-signal selecting circuit selecting a highest voltage from among command signals outputted from the lowest-voltage detecting circuits in each of the ninth semiconductor elements, wherein
the power-supply control circuit controls the voltage applied to the LED array to a voltage lower than an initial set voltage based on the command signal selected by the command-signal selecting circuit.

17. An LED driving circuit driving an LED array in which n LED strings in each of which m LEDs are connected in series are arranged in parallel, the LED driving circuit comprising:
n semiconductor elements each of which is connected to each of the LED strings in series and drives the LED string with a constant current; and
n constant-current control circuits controlling on voltages of the semiconductor elements so that currents flowing to the LED strings become constant currents, wherein
the constant-current control circuit has a delay circuit delaying an inputted digital dimming signal, outputs the digital dimming signal delayed by the delay circuit, and inputs the digital dimming signal to the constant-current control circuit of a next stage.

18. An image display device using the LED array driven by the LED driving circuit according to claim 17 as a backlight.

19. An LED driving circuit driving an LED array in which n LED strings in each of which m LEDs are connected in series are arranged in parallel, the LED driving circuit comprising:
n tenth semiconductor elements having a vertical structure, each of which is connected to each of the LED strings in series and drives the LED string with a constant current, wherein
on voltages of the tenth semiconductor elements are controlled so that the currents flowing to the LED strings become constant currents, and
a lowest voltage among terminal voltages of the tenth semiconductor elements on an LED string side is selected, and a voltage applied to the LED array is controlled to a voltage lower than an initial set voltage based on a difference between the lowest voltage and a predetermined set voltage.

20. The LED driving circuit according to claim 19, wherein,
when the tenth semiconductor elements are brought into an off state or a state close to an off state by an inputted digital dimming signal, a lowest voltage among the terminal voltages at a point immediately before a signal level of the digital dimming signal becomes high is used as the lowest voltage.
